(19) United States
(12) Patent Application Publication
(10) Pub. No.: US 2013/0084122 A1
(43) Pub. Date: Apr. 4, 2013

(54) BINDER RING

(71) Applicant: Soo Dong Sa, Namyangju-si (KR)

(72) Inventor: Soo Dong Sa, Namyangju-si (KR)

(21) Appl. No.: 13/702,367

(22) PCT Filed: Jun. 9, 2011
(86) PCT No.: PCT/KR2011/004236

§ 371 Date: Dec. 6, 2012

(30) Foreign Application Priority Data
Jun. 11, 2010 (KR) 10-2010-0055522

(51) Int. Cl. B42F 3/04

(52) U.S. Cl. CPC B42F 3/04
USPC 402/20

(57) ABSTRACT

A binder ring for bookbinding can be easily closed and opened independently by the operating force applied from a user, has a simple structure that includes a vertical open restricting element preventing the binder ring from being opened in the vertical direction and a horizontal open restricting element preventing the binder ring from being opened in the horizontal direction. The binder ring includes an elastic main body and an engaging portion formed at both ends of the body to be separately engaged with each other, wherein the engaging portion includes a vertical open restricting element and a horizontal open restricting element. The engaging portion also includes first and second engaging pieces extended toward each other from both ends of the body, and horizontal open restricting element and vertical open restricting element, wherein the first and second engaging pieces corresponding with each other are arranged to be engaged with each other.

### TECHNICAL FIELD

The present invention relates to a binder ring for bookbinding, and more particularly, to a binder ring for bookbinding having a simple structure and capable of reducing manufacturing cost, performing easy mounting, and providing high usability.

### BACKGROUND ART

In general, pincers, clips, staplers, binders and various holders are used as members configured to bind various materials such as paper, vinyl sheets, fabric, plastic, and leather, which can be bound, or arrange and store documents or notes.

FIGS. 1A to 1C are views showing an example of a conventional holder and binder.

FIG. 1A shows a spring type holder (ring bookbinding). A large number of objects B (for example, papers), which are to be bound, are punched using a punching machine to form punched holes, and then the objects B having the punched holes are bound in a state in which a spring holder 1 is disposed at an arbitrary position, manufacturing a bound book.

However, in order to use the spring holder 1, a separate device (for example, a bookbinder), which incurs costs, is needed, and thus burden of expenses is imposed and fixing and disengaging operations after punching the objects B require skill.

In addition, in order to disengage a binder ring from the bound objects, the separate device (the bookbinder) used upon bookbinding should be reused, which is a very inconvenient operation. Further, since the separate device (the bookbinder) is generally manufactured to a specific size (for example, an A4 size), the separate device cannot be used when the size of the objects B is different.

FIG. 1B is a view showing another conventional binder. A binder 2 includes a plurality of binder rings 2-1 fixed to a support member 2-2. After two to six binder rings 2-1 are opened by elasticity to a certain size, the binder rings 2-1 are inserted into the corresponding punched holes formed in a plurality of objects B (for example, papers), binding the plurality of objects B.

In the case of the binder 2 having the above-mentioned structure, while disengagement and fixing of the papers, which are objects, become easy, the structure is somewhat complex, which increases a manufacturing cost. In addition, a diameter of the binder ring 2-1 is larger than a thickness of the inserted objects B, causing inconvenience in handheld use. Further, since both sides of the objects B are restricted by the support members 2-2, the objects B inserted between the binders 2 cannot be rotated 360 degrees, which causes a disadvantage in use.

FIG. 1C is a view showing still another conventional binder. A single binder ring 3 formed of a metal material or a synthetic resin is inserted into a punched hole formed in a plurality of papers. Since the binder ring 3 shown in FIG. 1C has a simple structure in comparison with the binder 2 including the spring holder 1 of FIG. 1A or the plurality of binder rings 2-1 shown in FIG. 1B, the binder ring 3 can be easily mounted without a separate device. However, when the single binder ring 3 is used, since a large number of papers are likely to move in left and right directions (disordered), the papers cannot be neatly managed.

### DISCLOSURE

### Technical Problem

In order to solve the foregoing and/or other problems, it is an aspect of the present invention to provide a binder ring for bookbinding capable of easy engagement and disengagement through only an operating force of a user, separate engagement and disengagement, and increase in usability according to diversification in color or size.

In addition, it is an aspect of the present invention to provide a binder ring for bookbinding capable of simplifying a structure thereof, remarkably reducing a manufacturing cost, and maintaining a firm coupling force by including a vertical (upward and downward) disengagement restriction unit and a horizontal (left and right) disengagement restriction unit to prevent disengagement in a vertical (upward and downward) direction and a horizontal (left and right) direction.

### Technical Solution

The foregoing and/or other aspects of the present invention may be achieved by providing a

In addition, another aspect of the present invention may be achieved by providing a binder ring for bookbinding configured to bind binding objects having a punched hole to bind a book, including: a main body having elasticity and engaging portions formed at both longitudinal ends of the main body and configured to disengageably engage with each other. The engaging portions include a vertical disengagement restriction unit configured to prevent disengagement in a vertical (upward and downward) direction and a horizontal disengagement restriction unit configured to prevent disengagement in a horizontal (left and right) direction.

The engaging portions may be constituted by a plurality of first and second engaging pieces extending from both longitudinal ends toward each other and in which the horizontal disengagement restriction unit and the vertical disengagement restriction unit are formed, and the corresponding first engaging pieces and second engaging pieces may be alternately disposed to engage with each other.

The horizontal disengagement restriction unit of the present invention may include a fixing protrusion formed at the first engaging piece and a fixing groove formed at a side surface of the second engaging piece to correspond to the fixing protrusion.

Here, the fixing groove may be divided into a horizontal section formed at a front end thereof and a curved section formed at a longitudinal end so that the fixing protrusion enters the curved section along the horizontal section formed at the front end of the fixing groove and is disposed at a longitudinal end of the curved section by elasticity of the first engaging piece. Meanwhile, a push section may be formed at a surface of the first engaging piece at which the fixing protrusion is formed.

The horizontal disengagement restriction unit of the present invention may be constituted by a fixing protrusion formed at a front end lower portion of the first engaging piece and a concave section formed at a lower surface of the second engaging piece and corresponding to the fixing protrusion. The fixing protrusion and the front end of the concave section may be formed as inclined surfaces so that the fixing protrusion is accommodated in the concave section by elasticity of the first engaging piece when the fixing protrusion corresponds to the concave section upon engagement of the first engaging piece and the second engaging piece.

The disengagement restriction unit according to another embodiment may include a projection guide formed at a side surface of the second engaging piece and a guide groove formed at the corresponding side surface of the first engaging piece and into which the projection guide is inserted upon engagement of the first engaging piece and the second engaging piece.

Meanwhile, the vertical disengagement restriction unit and the horizontal disengagement restriction unit may be constituted by a projection formed at a longitudinal end of the main body and an engaging groove formed at another longitudinal end and corresponding to the projection, and here, a fixing key is formed at one side of the projection, and a fixing groove to which the fixing key is hooked and fixed is formed at the engaging groove.

The main body constituting the binder ring of the present invention may include a reinforcement rib having a predetermined height formed at the inner surface, the rib may be formed at an edge or a center of the main body and may extend in a circumferential direction thereof, or the rib may be formed at an edge and a center of the main body and may extend in a circumferential direction thereof.

In addition, at least one reinforcement rib may be formed at a predetermined region of an inner circumferential surface of the main body, and a stopper having a thickness corresponding to a height of the rib may be formed at the other region.

The horizontal disengagement restriction unit according to still another embodiment applied to the binder ring according to the present invention may include an extension piece extending outward from a central engaging piece of the first engaging piece, and a concave section formed at a lower portion of the second engaging piece corresponding to the central engaging piece to a predetermined depth, and here, the extension piece of the pushed first engaging piece may return and may be accommodated in the concave section of the second engaging piece upon engagement of the first engaging piece and the second engaging piece.

As the vertical disengagement restriction unit, a first support piece extending from the main body corresponding to both of the lateral engaging pieces of the first engaging piece toward the first engaging piece and formed at the outside of the second engaging piece may be used, and the front end of the lateral engaging piece of the first engaging piece may be supported in a state disposed on the first support piece upon engagement of the first engaging piece and the second engaging piece.

The vertical disengagement restriction unit may further include a second support piece formed inside the lateral engaging piece of the first engaging piece, and in the vertical disengagement restriction unit, upon engagement of the first engaging piece and the second engaging piece, the second engaging piece may be disposed and supported on the second support piece.

### Advantageous Effects

According to the present invention, the binder ring according to the present invention has advantages of easy engagement and disengagement through a manual operation force of a user, a separate use, and an effective use according to a thickness of binding objects through diversification in color and size.

In addition, the binder ring according to the present invention can simplify a structure thereof to remarkably reduce a manufacturing cost, and enable manual engagement and disengagement to improve use convenience.

In particular, the binder ring according to the present invention can maintain a firm engaging force through the vertical disengagement restriction unit and the horizontal disengagement restriction unit, and easily disengage the engaging portions using the push section separately installed at any one engaging piece after engagement of the engaging portions, i.e., after engagement of the engaging piece.

Further, the rib provided along both edges of the main body can prevent cross movement of the bound objects to enable neater arrangement and storage of documents.

### DESCRIPTION OF DRAWINGS

The above and other aspects and advantages of the present invention will become apparent and more readily appreciated from the following description of exemplary embodiments, taken in conjunction with the accompanying drawings of which:

FIGS. 1A to 1C are views examples of conventional holders and binders;

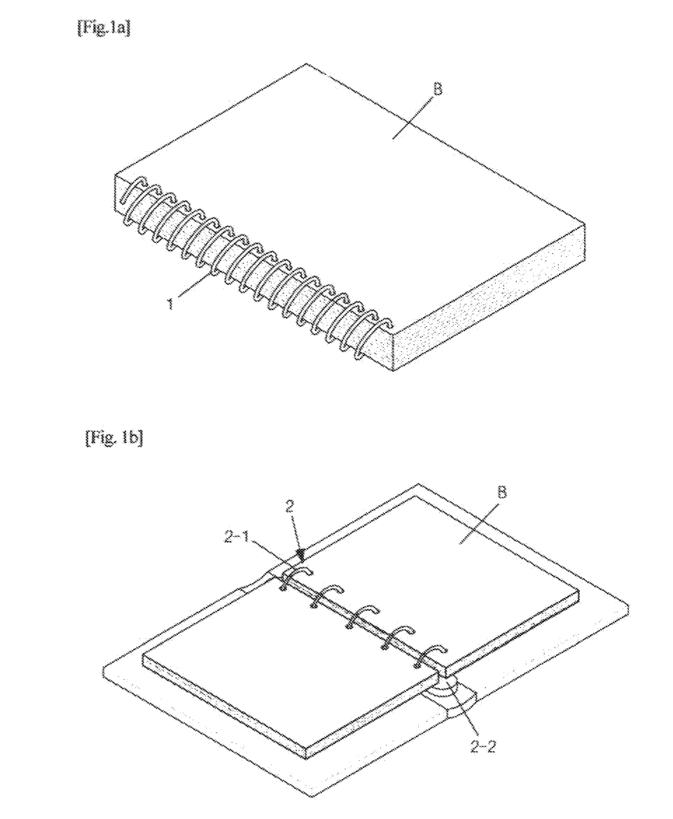

FIG. 2 is a schematic perspective view of a binder ring for bookbinding according to the present invention;

FIG. 3 is a perspective view showing an assembled state of the binder ring for bookbinding according to the present invention;

FIG. 4A is a view showing a binder ring according to a first embodiment of the present invention;

FIG. 4B is a view showing a relation between a fixing groove and a fixing protrusion shown in FIG. 4A;

FIG. 5 is a view showing a binder ring according to a second embodiment of the present invention, FIG. 5(a) showing a perspective view of the binder ring and FIG. 5(b) showing a view of a relation between a fixing protrusion formed at a first engaging piece and a concave section formed at a main body when the first engaging piece shown in FIG. 5(a) is engaged with a second engaging piece, wherein an upper portion shows a state before engagement and a lower portion shows a state after engagement;

FIG. 6 is a view showing a binder ring according to a third embodiment of the present invention;

FIG. 7 is a view showing examples of various shapes of an engaging portion of the binder ring;

FIG. 8 is a view showing various shapes of ribs of the binder ring according to the present invention;

FIG. 9 is a cross-sectional view showing various shapes of a main body of the binder ring according to the present invention;

FIG. 10 is a cross-sectional view of the binder ring formed of different kinds of materials according to the present invention;

FIG. 11 is a view showing a state of a use example of the binder ring according to the present invention;

FIGS. 12 and 13 are views showing another use example of the binder ring according to the present invention;

FIG. 14 is a perspective view of a binder ring according to a fourth embodiment of the present invention;

FIG. 15 is a view showing a relation between a central engaging piece of a first engaging piece and a second engaging piece shown in FIG. 14;

FIG. 16 is a view showing a relation between an inclined section of a main body and an inclined surface of a lateral engaging piece shown in FIG. 14; and

FIG. 17 is a front view of the binder ring shown in FIG. 14.

### MODE FOR INVENTION

Hereinafter, exemplary embodiments of a binder ring for bookbinding according to the present invention will be described in detail with reference to the accompanying drawings.

As described above, the binder ring is a member inserted into a punched hole formed by collecting and punching various sizes of binding objects to bind the binding objects. Here, the binding objects are referred to as objects formed of all materials such as paper, vinyl sheets, fabric, plastic, and leather, which can be bound, i.e., objects to be bound after the punched hole is formed at a specific region.

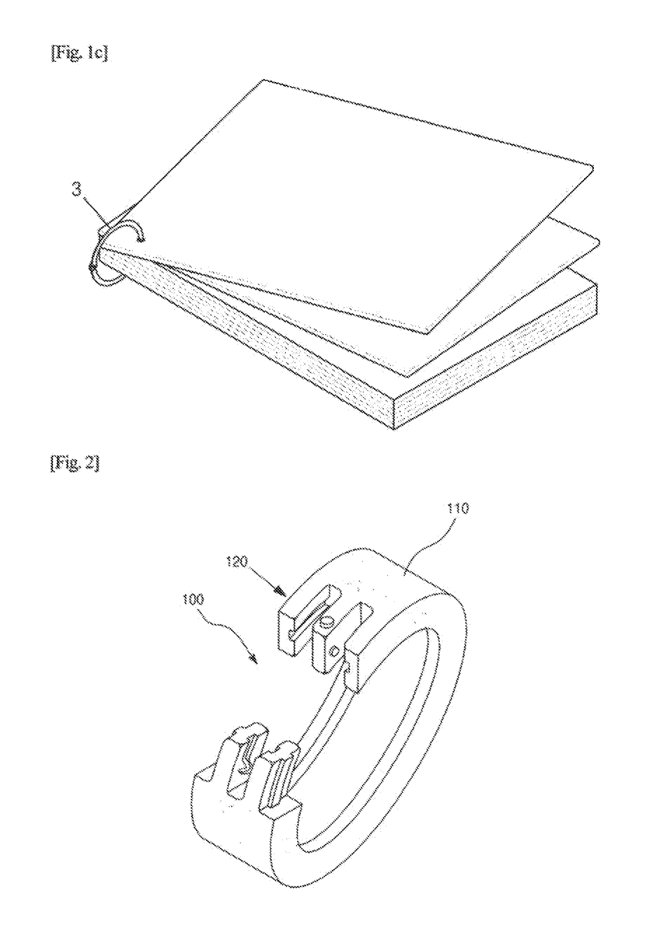

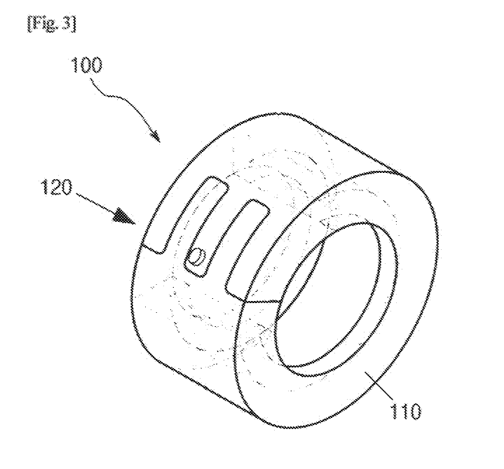

FIG. 2 is a schematic perspective view of the binder ring according to the present invention, and FIG. 3 is a perspective view showing an assembled state of the binder ring according to the present invention. A binder ring 100 according to the present invention is constituted by a main body 110 formed of a material having elasticity, and an engaging portion 120 configured to bind the binding objects with the main body 110.

The main body 110 has an elastic structure that elastically deforms in an arbitrary region through a manipulation force of a user and opens to be inserted into the punched hole formed in the binding objects.

The main body 110 may be formed of an elastic material causing elastic deformation, and thus may have longitudinal ends that are separated from and approach each other by a manipulation force of a user.

The main body 110 may be formed of a plastic-based material such as a synthetic resin, a metal, a non-metal, a metal alloy, and so on. The main body 110 is manufactured to have a predetermined length and width, and both longitudinal ends, i.e., the engaging portions 120 of the main body 110, may have a predetermined interval in order to insert the binding objects in a state before use.

The engaging portions 120 have structures integrally formed with both open longitudinal ends of the main body 110 and engageable with each other in a facing state. The main body 110 and the engaging portions 120 may be formed of the same material or different materials.

In a state in which the main body 110 is inserted into the punched hole of the binding objects through the engaging portion 120, a first engaging piece 121 and a second engaging piece 122 are pressed and engaged with each other to bind the binding objects (in a state of FIG. 3, the binding objects are not shown).

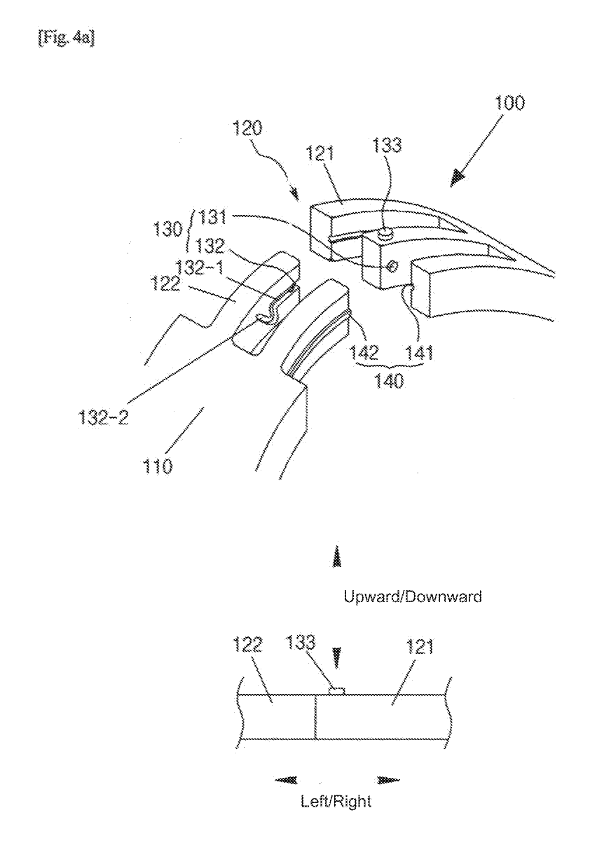

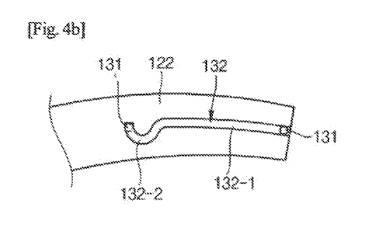

FIG. 4A is a view showing the binder ring according to the first embodiment of the present invention. The binder ring 100 according to the embodiment includes the main body 110 having a predetermined width and the engaging portions 120 formed at both longitudinal ends of the main body 110. Here, the main body 110 may have a circular shape, an oval shape, or a polygonal shape, a portion of which is cut.

After the engaging portions 120 formed at both longitudinal ends of the main body 110 are inserted into the punched holes formed in the binding objects such as papers, memo sheets, and leaflets, the engaging portions 120 are engaged with each other to bind the binding objects.

The engaging portion 120 is constituted by a plurality of first and second engaging pieces 121 and 122 extending from both longitudinal ends of the main body 110 toward each other to engage both longitudinal ends of the main body 110. Here, the first engaging pieces 121 are disposed to be spaced apart from the neighboring pieces, and the second engaging pieces 122 are also disposed to be spaced apart from the neighboring engaging pieces. In particular, the first engaging pieces 121 and the second engaging pieces 122 are disposed to be alternately engaged with each other.

The engaging portion 120 includes a horizontal (left and right) disengagement restriction unit 130 and a vertical (upward and downward) disengagement restriction unit 140 configured to prevent disengagement in a horizontal (left and right) direction and disengagement in a vertical (upward and downward) direction, respectively. Here, the vertical (upward and downward) disengagement direction refers to a direction perpendicular to an engaging direction of the engaging portion 120, and the horizontal (left and right) disengagement direction refers to the engaging direction of the engaging portion 120.

As shown in FIG. 4A, for example, the horizontal disengagement restriction unit 130 may be constituted by a fixing protrusion 131 formed at a side surface of any one first engaging piece 121 of the engaging portion 120 and a fixing groove 132 formed at a side surface of the second engaging piece 122 corresponding to the fixing protrusion 131.

While FIG. 4A shows the fixing protrusion 131 formed at one side surface of the first engaging piece 121 and the fixing groove 132 formed at one side surface of the second engaging piece 122, the fixing protrusions 131 may be formed at both side surfaces of any one first engaging piece 121 and the fixing grooves 132 may be formed at one side surfaces of the two second engaging pieces 122 corresponding thereto, and the fixing protrusion 131 may be formed at one side surface of any one first engaging piece 121 and the fixing groove 132 may be formed at one side surface of the one second engaging piece 122 corresponding thereto.

The vertical disengagement restriction unit 140 is constituted by a projection guide 142 formed at a side surface of any one second engaging piece 122 and a guide groove 141 formed at a side surface of the first engaging piece 121 corresponding thereto.

Upon engagement of the engaging portion 120, i.e., when the first engaging piece 121 is engaged with the second engaging piece 122, the first engaging piece 121 and the second engaging piece 122 are engaged by the vertical disengagement restriction unit 140 and fixed through the horizontal disengagement restriction unit 130.

That is, after the main body 110 having both spaced (opened) longitudinal ends is inserted into the punched holes of the objects to be bound, the projection guide 142 of the vertical disengagement restriction unit 140 and the guide groove 141 corresponding thereto are assembled and simultaneously the fixing protrusion 131 of the horizontal disengagement restriction unit 130 is inserted into the fixing groove 132, and the first engaging piece 121 is engaged with the second engaging piece 122.

Here, as shown in FIG. 4B, the fixing groove 132 is divided into a horizontal section 132-1 formed at a front end thereof and a U-shaped (or V-shaped) curved section 132-2 formed at a longitudinal end. After the fixing protrusion 131 moves along the horizontal section 132-1 formed at the front end of the fixing groove 132, when moves into the curved section 132-2, the fixing protrusion 131 is disposed at a longitudinal end of the curved section 132-2 by elasticity of the first engaging piece 121.

In this state, even when external forces are applied to the first engaging piece 121 and the second engaging piece 122 in opposite directions, disengagement of the fixing protrusion 131 and the fixing groove 132, i.e., disengagement of the first engaging piece 121 and the second engaging piece 122, does not occur.

Meanwhile, a push section 133 may be formed at an upper surface of the first engaging piece 121 at which the fixing protrusion 131 is formed. The push section 133 is configured to easily disengage the fixing protrusion 131 fixed to the fixing groove 132, which are engaged as described above.

When the objects bound by the binder ring 100 are disengaged, as a user pushes a push section 133, the first engaging piece 121 at which the push section 133 and the fixing protrusion 131 are formed is pushed downward, and thus the fixing protrusion 131 is separated from the curved section 132-2 of the fixing groove 132 to be disposed at the horizontal section 132-1.

In this state, even when the user does not pull the first engaging piece 121 and the second engaging piece 122 in opposite directions, the first engaging piece 121 and the second engaging piece 122 of the engaging portion 120 are spaced a predetermined gap from each other by elasticity of the main body 110 and return an initial state (a state of FIG. 2), and then the user can disengage and remove the objects through any one engaging piece 121 or 122.

Meanwhile, in a state in which the fixing protrusion 131 is disposed at the horizontal section 132-1 of the fixing groove 132, the user may pull both longitudinal ends (i.e., the engaging portion 120) of the main body 110 in opposite directions to disengage the engaging state of the first engaging piece 121 and the second engaging piece 122.

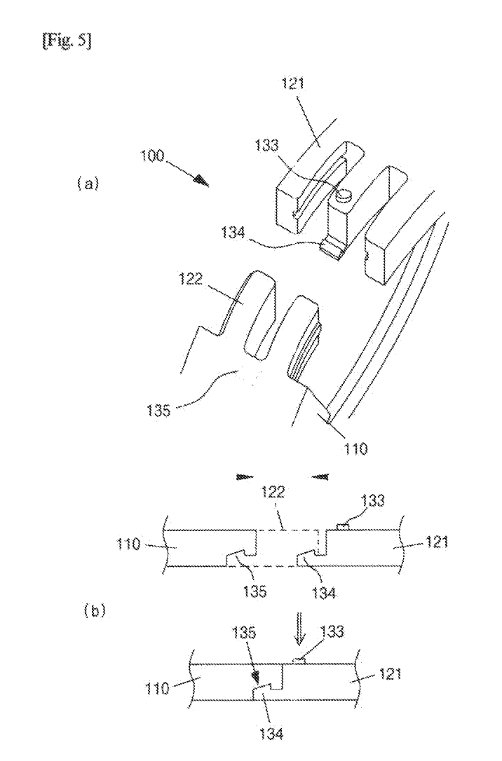

FIG. 5 is a view showing a binder ring 100 according to a second embodiment of the present invention, FIG. 5(a) showing a partial perspective view of the binder ring. Meanwhile, in FIG. 5(a), only a portion of the main body 110 in which the binder ring 100 has a predetermined width and the engaging portions 120 formed at both longitudinal ends of the main body 110 is shown.

The binder ring 100 shown in FIG. 5(a) has the same entire structure as of the binder ring 100 shown in FIG. 4A, except for the horizontal disengagement restriction unit, and thus overlapping description of the same structure will be omitted.

As a horizontal disengagement restriction unit of the binder ring 100 according to the embodiment, a fixing protrusion 134 is formed at a lower portion of a front end of the first engaging piece 121, and a concave section 135 corresponding thereto is formed at a lower surface of the main body 110 adjacent to the second engaging piece 122. Here, a front end upper surface of the fixing protrusion 134 and an upper surface of the concave section 135 may be formed as inclined surfaces.

FIG. 5(b) is a view showing a relation between the fixing protrusion 134 formed at the first engaging piece 121 and the concave section 135 formed at the main body 110 when the first engaging piece and a second engaging piece shown in FIG. 5(a) are engaged, an upper portion showing a state before engagement and a lower portion showing a state after engagement.

In the structure described as above, when the fixing protrusion 134 corresponds to the concave section 135 upon engagement of the first engaging piece 121 and the second engaging piece 122, the fixing protrusion 134 is completely accommodated in the concave section 135 by elasticity of the first engaging piece 121, and thus a firm fastening state of the first engaging piece 121 and the second engaging piece 122 is maintained as long as an artificial (horizontal direction) external force is not applied.

Even in this embodiment, a push section 133 may be further formed on an upper surface of the first engaging piece 121 at which the fixing protrusion 134 is formed. When the objects bound by the binder ring 100 are disengaged, as the user pushes the push section 133, the first engaging piece 121 at which the push section 133 and the fixing protrusion 134 are formed is pushed downward, and thus the fixing protrusion 134 is separated from the concave section 135. In this state, even when the user does not pull the first engaging piece 121 and the second engaging piece 122 in opposite directions, the first engaging piece 121 and the second engaging piece 122 of the engaging portion 120 are spaced a predetermined gap from each other and return to an initial state (a state of FIG. 2) by elasticity of the main body 110, and then the user can disengage and remove the objects through any one engaging piece 121 or 122.

Meanwhile, in a state in which the fixing protrusion 134 is separated from the concave section 135, as the user pulls both longitudinal ends (i.e., the engaging portion 120) of the main body 110 in opposite directions, the engaging state of the engaging portion 120, i.e., the engaging state of the first engaging piece 121 and the second engaging piece 122, can be released.

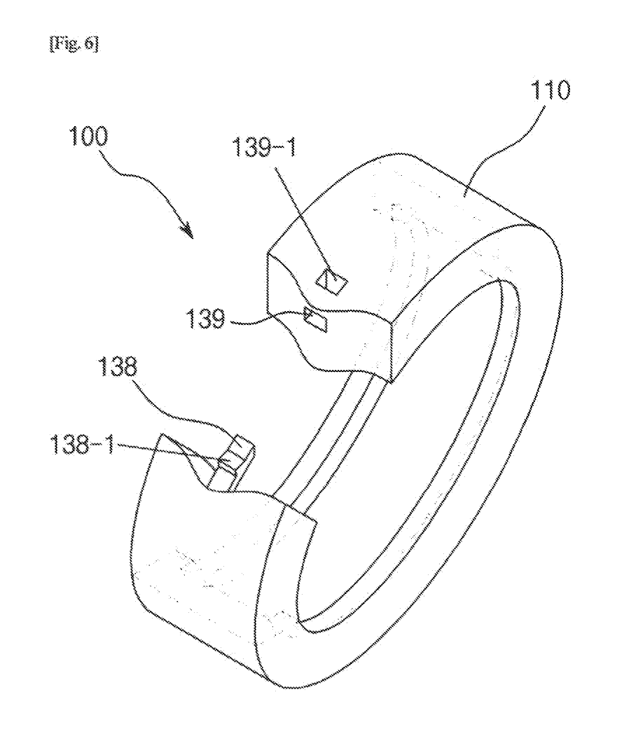

FIG. 6 is a view showing a binder ring 100 according to a third embodiment of the present invention. A projection 138 having a predetermined size is formed at one longitudinal end of the main body 110, and an engaging groove 139 corresponding to the projection 138 is formed at another longitudinal end.

Here, a fixing groove 139-1 may be formed such that a fixing key 138-1 is formed at one side of the projection 138 and the fixing key 138-1 is hooked by the engaging groove 139.

As described above, an example of the horizontal (left and right) disengagement fixing unit may be variously made through a protrusion and a groove by those skilled in the art, and it is not limited thereto but may be variously modified.

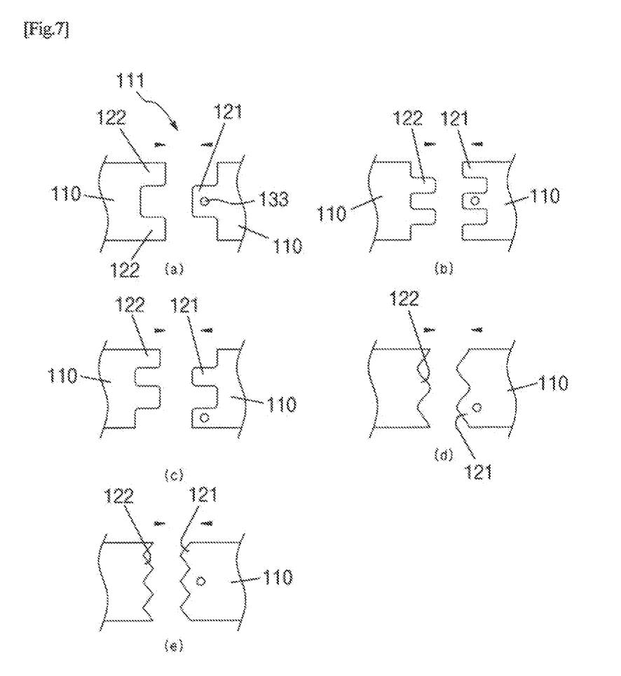

FIG. 7 is a view showing shapes of the engaging portion 120 of the binder ring 100 shown in FIG. 4A and FIG. 5(a), i.e., various shapes of the first and second engaging pieces 121 and 122.

As described above, in order to prevent them from being spaced in the horizontal (left and right) direction, the first and second engaging pieces 121 and 122 formed at both longitudinal ends of the main body 110 are formed and disposed to alternately engage with each other.

The engaging portion 120 may be constituted by one first engaging piece 121 and two second engaging pieces 122 as shown in FIG. 7(a), or may be symmetrically constituted by three first engaging pieces 121 and two second engaging pieces 122 as shown in FIG. 7(b). In addition, the engaging portion 120 may be asymmetrically constituted by two first engaging pieces 121 and two second engaging pieces 122 as shown in FIG. 7(c).

Further, one, two or more horizontal (left and right) disengagement restriction units may be provided, and one, two or more vertical (upward and downward) disengagement restriction unit 140 (a guide groove 141 and a projection guide 142) may be similarly provided.

Furthermore, as shown in FIGS. 7(d) and 7(e), the engaging portion 120 may have a corrugated shape (a wave shape) or a sawtooth shape, in which the engaging pieces 121 and 122 are engaged with each other. As described above, shapes of the engaging pieces of the engaging portion may be variously varied.

Meanwhile, when the objects (for example, papers) are bound using a binder ring for bookbinding 100 according to the present invention, a rib may be formed at the main body 110 to prevent the papers from being dislocated and maintain elasticity and reinforcement of the main body 110.

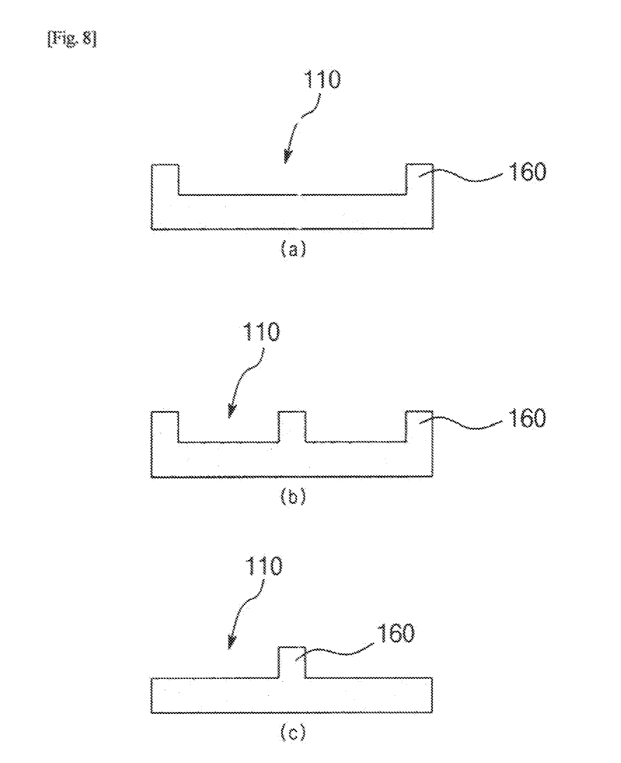

FIG. 8 is a cross-sectional view of the main body 110 of the binder ring 100 according to the present invention, showing a rib 160 having various shapes and formed at the main body 110.

As shown in FIG. 8(a), the rib 160 having a projection structure may be formed at an edge of an inner surface of the main body 110, and may extend in a circumferential direction.

In addition, as shown in FIG. 8(b), the rib 160 having a projection structure may extend from an edge and a center of the inner surface of the main body 110 in the circumferential direction, and as shown in FIG. 8(c), the rib 160 may extend from the center of the inner surface of the main body 110 in the circumferential direction.

In order to bind the binding objects using the binder ring having the main body 110 with the above-mentioned structure, a punched hole having a shape corresponding to a cross section of the main body 110 having the rib 160 formed at the surface thereof is formed, and the punched hole may be formed by a separate punching machine.

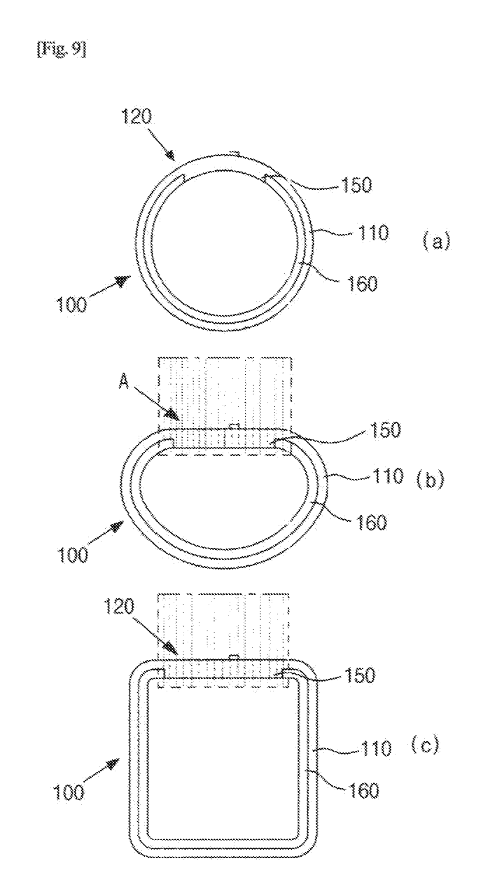

FIG. 9 is a view showing shapes of the binder ring 100 according to the present invention, i.e., various cross-sectional shapes of the main body 110.

While the binder ring in which the main body 110 has a circular shape is proposed as an example of the binder ring 100 according to the present invention shown in FIGS. 2, 3 and 9(a), in the case of the circular shape, a gap between the binding objects arranged according to a radius of curvature of the main body 110 may be different when the amount of the binding objects is large.

Accordingly, as shown in FIG. 9(b), a region (a region “A”) in which the bound objects are in contact with the region of the main body 110 may have a planar surface (i.e., a semi-circular shape). Due to such a shape, longitudinal ends of the bound objects (shown in dotted lines) are arranged in a planar shape.

In addition, as shown in 9(c), the main body 110 having a rectangular shape may be used, and the main body having various shapes, i.e., the main body 110 having different radii of curvature, may be used as shown in FIG. 9(b).

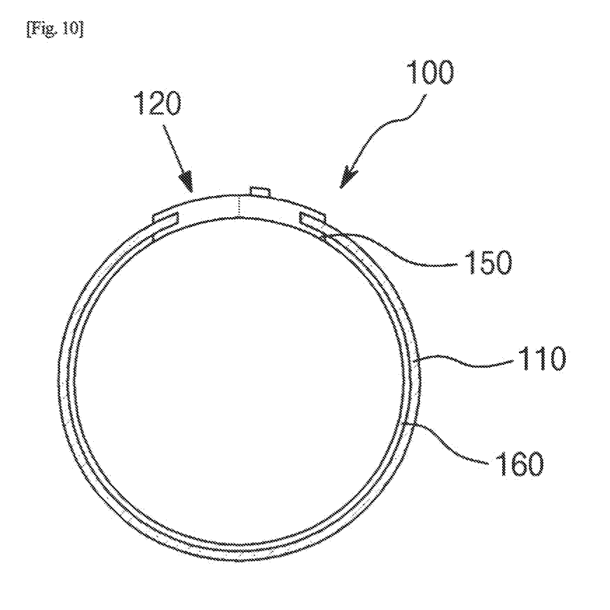

FIG. 10 is a view showing the binder ring of another embodiment according to the present invention formed of a material different from the main body 110 and the engaging portion 120, and the main body 110 may be formed of a metal material and the engaging portion 120 may be formed of a synthetic resin.

Meanwhile, in FIGS. 9 and 10, reference numeral 160 is a reinforcement rib formed at the inner surface of the main body 110.

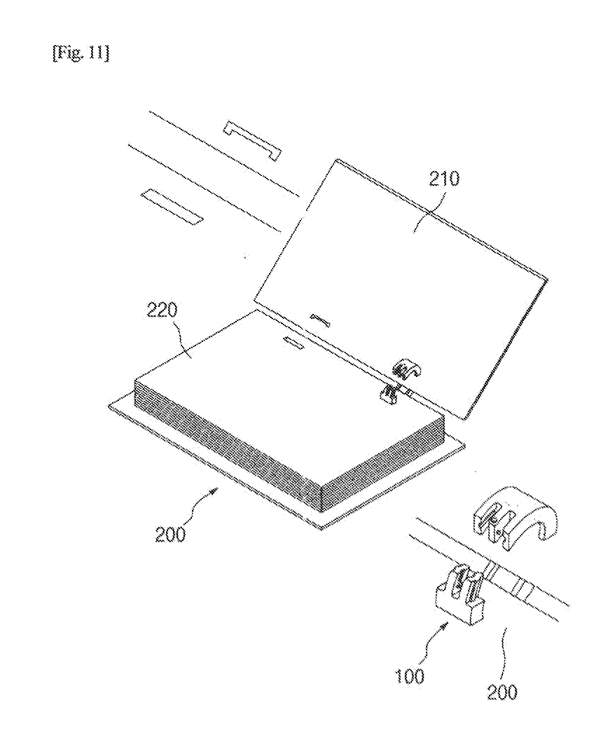

FIG. 11 is a view showing a use state of the binder ring for bookbinding according to the present invention. As shown, a punched hole is formed in a plurality of binding objects 220 to insert the binder ring 100 thereinto, and the binder ring 100 is inserted into the punched hole.

According to necessity, a plurality of punched holes may be formed along a horizontal axis or a vertical axis of the objects 220, and the objects 220 may be fixed using one or a plurality of binder rings.

Meanwhile, the rib 160 formed at the main body 110 of the binder ring 100 may be formed at a portion of the region of the main body 110, and a stopper 150 (see FIGS. 9 and 10) having the same height and thickness as the rib 160 may be formed at the other of the region.

Specifically, the region in which the rib 160 is formed is formed at a region other than the region in which the engaging portion 120 is formed, in the entire area of the binder ring 100, and a stopper 150 having the same height or substantially the same thickness as the rib 160 is formed in the region of the engaging portion 120.

For example, in bookbinding of a large amount of binding objects 220, in general, the bookbinding matter 200 is constituted by covers 210 and binding papers 220 (i.e., binding objects). The covers 210 are disposed at a front surface and a rear surface of the binding papers 220 to be bound.

Here, a punched hole corresponding to a cross-sectional shape of the main body 110 having the rib 160 is formed at the cover 210, and the punched hole of the binding papers 220 is punched to have a cross-sectional area corresponding to a height of the rib 160. That is, this corresponds to a cross-section of the stopper 150, and the cover 210 passes the stopper region to be inserted into a rib region through press-fitting. In general, as the cover 210 is formed of a relatively solid material, the stopper 150 can be press-fitted into the punched hole but cannot be separated therefrom.

Accordingly, while the binding papers 220 can move along the entire binder ring 100, the cover 210 cannot pass the stopper 150. Therefore, the covers 210 are disposed at both ends (boundaries with the rib region) of the region of the stopper 150 upon bookbinding, and the binding papers 220 are disposed therebetween. That is, the binder ring 100 of the present invention can maintain a good appearance because the engaging portion 120 is disposed inside the punched hole of the binding papers 220 due to contact between the stopper 150 and the cover 210.

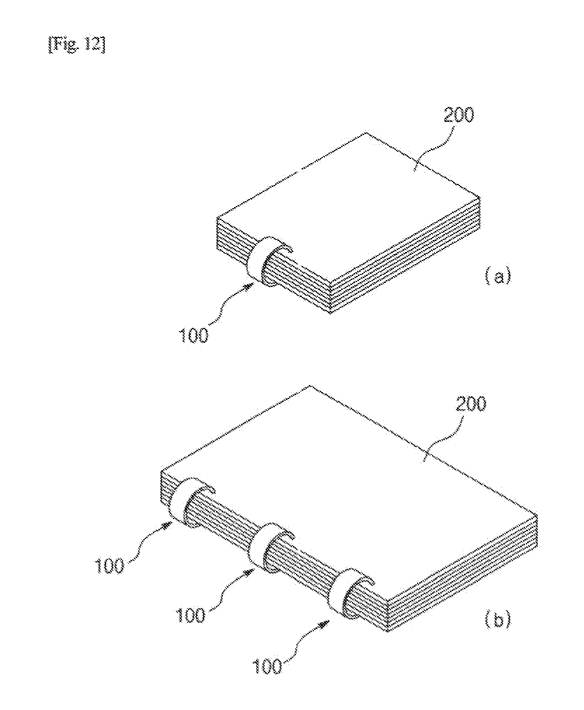

FIGS. 12 and 13 are views showing books bound through binder rings having various shapes. Binding objects having a relatively large size may be bound by one or more binder rings (FIGS. 12(b) and 13(b)) to constitute the bookbinding matter 200.

In addition, FIGS. 12(a) and 12(b) show the bookbinding matter 200 bound using a circular binder ring 100, and FIGS. 13(a) and 13(b) show the bookbinding matter 200 bound using a rectangular binder ring 100.

As shown in FIGS. 12 and 13, since the binder ring for bookbinding according to the present invention can be separately used, one or a plurality of binder rings can be used to implement conventional spring bookbinding or binder bookbinding.

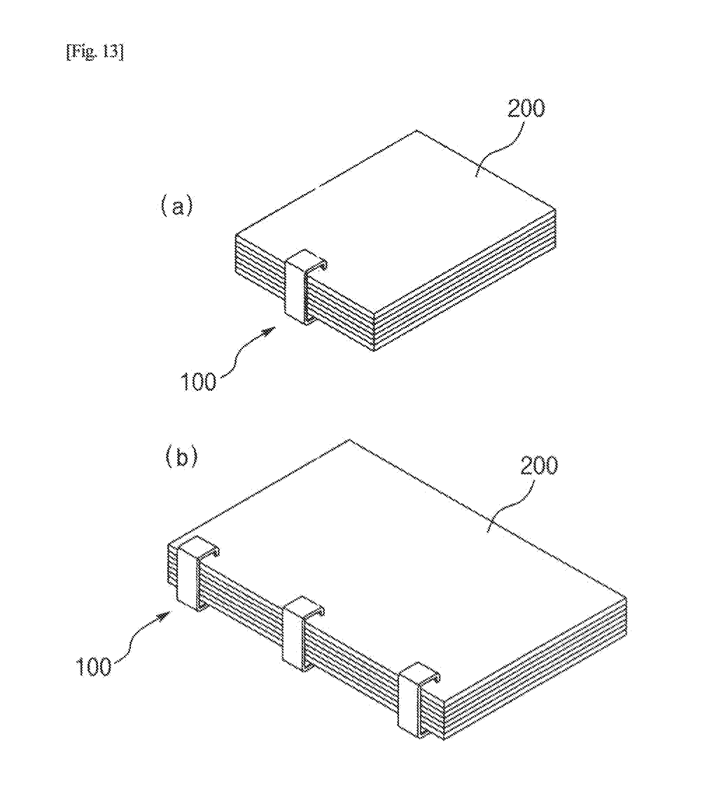

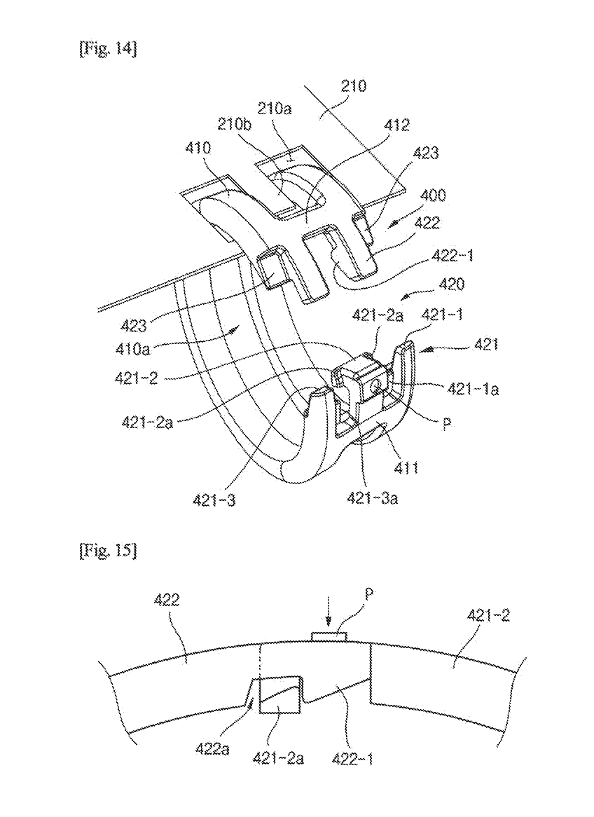

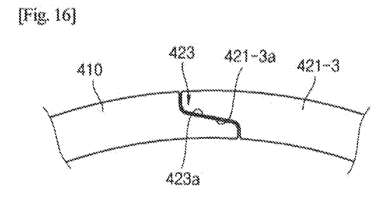

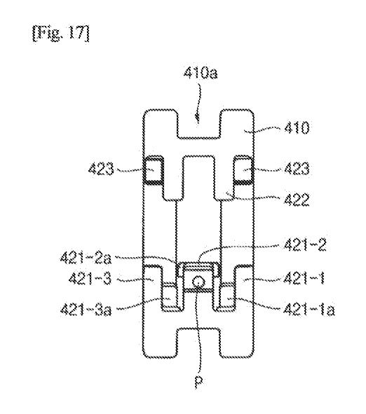

FIG. 14 is a perspective view of a binder ring according to a fourth embodiment of the present invention, FIG. 15 is a view showing a relation between a central engaging piece of a first engaging piece and a second engaging piece shown in FIG. 14, FIG. 16 is a view showing a relation between an inclined section of a main body and an inclined surface of a lateral engaging piece shown in FIG. 14, and FIG. 17 is a front view of the binder ring shown in FIG. 14.

A binder ring 400 according to the embodiment includes a main body 410 having a predetermined width and engaging portions 420 formed at both longitudinal ends of the main body 410. Meanwhile, FIG. 14 shows a state in which the engaging portions 420 are spaced apart from each other.

The main body 410 constituting the binder ring 400 according to the present invention has the same structure, material and characteristics as the main body 110 of the binder ring 100 according to the first to third embodiments, and thus overlapping description thereof will be omitted.

The engaging portion 420 is constituted by a plurality of first and second engaging pieces 421 and 422 extending from both longitudinal ends of the main body 410 toward each other to engage both longitudinal ends of the main body 410.

Here, the first engaging piece 421 is disposed to be spaced apart from the neighboring engaging pieces, and the second engaging piece 422 is also disposed to be spaced apart from the neighboring engaging pieces. In particular, the first engaging piece 421 and the second engaging piece 422 are alternately disposed to engage with each other.

Meanwhile, while the number of engaging pieces is not limited, in the binder ring 400 according to the embodiment, the engaging portion 420 may include three first engaging pieces 421 spaced a predetermined interval from each other, and two second engaging pieces 422 corresponding to spaces between the first engaging pieces 421.

The horizontal disengagement restriction unit of the embodiment will be described below.

Lateral engaging pieces 421-1 and 421-3 disposed at both sides of the first engaging pieces 421 have a thickness that is gradually reduced toward a front end, and thus a lower surface thereof (a surface directed toward a center of the main body 410) is an inclined surface. A central engaging piece 421-2 corresponding to a space between the two second engaging pieces 422 has extension pieces 421-2a horizontally extending from both sides of a front end lower section toward the lateral engaging pieces 421-1 and 421-3.

A portion, i.e., a front end, of the region of each second engaging piece 422 has an inclined section 422-1 having a thickness that is gradually reduced toward a tip thereof. That is, a lower surface of the inclined section 422-1 (a surface directed toward a center of the main body 410) is an inclined surface, and a longitudinal end thereof is perpendicular to the inner surface of the second engaging piece 422.

Meanwhile, concave sections (shown as “422a” in FIG. 15) having a predetermined depth are formed at rear ends of the inclined sections 422-1 of the second engaging pieces 422, and the inner surfaces of the concave sections 422a are in an open state.

Here, each of the inclined sections 422-1 of the second engaging pieces 422 can be formed at only a portion of the region of the second engaging piece 422, i.e., the region having a width of about a half of a width of the second engaging pieces 422 to correspond to the extension piece 421-2a formed at the central engaging piece 421-2 of the first engaging piece 421.

Meanwhile, both of the lateral engaging pieces 421-1 and 421-3 have a structure having a thickness that is gradually reduced toward the front ends thereof, and thus lower surfaces of the lateral engaging pieces 421-1 and 421-3 are inclined toward the front ends thereof.

A configuration of the vertical disengagement restriction unit of the embodiment will be described below.

First support pieces 423 are formed at outer portions of the two second engaging pieces 422, i.e., portions of the regions of the main body 410 corresponding to both of the lateral engaging pieces 421-1 and 421-3 of the first engaging piece 421. A surface 423a of the first support piece 423 may be formed as an inclined surface, which is inclined downward toward an open end (specifically shown in FIG. 16).

Meanwhile, as still another vertical disengagement restriction unit, as shown in FIG. 17, second support pieces 421-1a and 421-3a having a predetermined area are formed inside both of the lateral engaging pieces 421-1 and 421-3 of the first engaging piece 421, and the second support pieces 421-1a and 421-3a correspond to the two second engaging pieces 422.

Functions of the binder ring 400 having the above-mentioned structure will be described with reference to FIGS. 14, 15, 16 and 17 as follows.

A user inserts the engaging portion 420 formed at both longitudinal ends of the main body 410 into the punched hole formed at the binding objects such as papers, memo sheets, and leaflets, and then presses the first engaging piece 421 and the second engaging piece 422 of the engaging portion 420 toward each other.

Here, the central engaging piece 421-2 of the first engaging piece 421 is disposed in a space between the second engaging pieces 422, and both of the extension pieces 421-2a of the central engaging piece 421-2 correspond to the inclined sections 422-1 of the second engaging piece 422s. According to the continuous pressing, both of the extension pieces 421-2a, i.e., the central engaging pieces 421-2, are pushed by the lower inclined surfaces of the inclined sections 422-1 of the second engaging pieces 422 and moved along the lower inclined surfaces of the inclined sections 422-1.

According to the continuous pressing, when both of the extension pieces 421-2a of the central engaging piece 421-2 of the first engaging piece 421 are separated from the inclined surfaces of the inclined sections 422-1 of the second engaging pieces 422, the first engaging piece 421, i.e., the central engaging piece 421-2, returns to its original state by elasticity (upward movement of FIG. 15), and thus the extension piece 421-2a is accommodated in the concave section 422a formed at the rear end of the inclined section 422-1 of the second engaging piece 422.

In this state, a rear vertical surface of each of the extension pieces 421-2a of the central engaging piece 421-2 comes in contact with a surface of a front wall surface (i.e., a rear vertical surface of the inclined section 422-1) constituting the concave section 422a, and thus the central engaging piece 421-2 of the first engaging piece 421 is firmly fastened to the second engaging pieces 422 (a state of FIG. 15).

In this state, the engaging state of the first engaging piece 421 and the second engaging piece 422 is not released as long as the rear vertical surfaces of both of the engaging pieces 421-2a are not intentionally separated from the rear vertical surfaces of the inclined sections 422-1 of the second engaging piece 422.

In order to disengage the first engaging piece 421 and the second engaging piece 422, the user pushes the central engaging piece 421-2 to move the central engaging piece 421-2 toward the center of the main body 410, and thus the contact of the rear vertical surfaces of both of the extension pieces 421-2a of the central engaging piece 421-2 and the rear vertical surfaces of the inclined sections 422-1 of the second engaging pieces 422 is released.

In this state, even when the user does not pull the first engaging piece 421 and the second engaging piece 422 in opposite directions, the first engaging piece 421 and the second engaging piece 422 of the engaging portion 420 return to the initial state (the same as the state of FIG. 2) spaced a predetermined gap from each other by elasticity of the main body 410, and then the user can separate and remove the binding objects through any one engaging piece 421 or 422.

Meanwhile, in a state in which the contact between the rear vertical surfaces of both of the extension pieces 421-2a of the central engaging piece 421-2 of the first engaging piece 421 and the rear vertical surface of the inclined section 422-1 of the second engaging piece 422 is released, the user can pull the first engaging piece 421 and the second engaging piece 422 in opposite directions to release the engaging state between the first engaging piece 421 and the second engaging piece 422.

Here, a push section P having a predetermined height is formed at an upper portion of the central engaging piece 421-2 of the first engaging piece 421, and thus the central engaging piece 421-2 of the first engaging piece 421 disposed on the same line as the surface of the second engaging piece 422 can be easily pushed.

Meanwhile, as shown in FIG. 16, the front ends of both of the lateral engaging pieces (only one engaging piece 421-3 is shown in FIG. 16) of the first engaging piece 421 are disposed on the first support pieces (only one first support piece 423 is shown in FIG. 16) formed at outer portions of the two second engaging pieces 422. Accordingly, in a state in which the first engaging piece 421 is engaged with the second engaging piece 422, lateral engaging pieces 421-3 of the first engaging piece 421 are supported by the first support piece 423 (extending from the main body 410).

In particular, the front ends of both of the lateral engaging pieces 421-3 have a thickness that is increased toward a rear side thereof (an opposite portion of a portion corresponding to the second engaging piece) to form a lower surface 421-3a as an inclined surface, and the surface 423a of the first support piece 423 is formed as an inclined surface inclined upward toward a rear side thereof (i.e., an opposite portion of a portion corresponding to the first engaging piece). Accordingly, upon engagement of the first engaging piece 421 and the second engaging piece 422, a minimum resistance occurs, and the lateral engaging piece 421-3 of the first engaging piece 421 can be naturally positioned on a support piece 423 formed on the outer portion of the second engaging piece 422.

In addition, after the engagement, since the front ends of both of the lateral engaging pieces 421-1 and 421-3 of the first engaging piece 421 are in contact with the rear wall surface of the support piece 423, excessive horizontal movement of the lateral engaging pieces 421-1 and 421-3, i.e., excessive movement of the first engaging piece 421 in the engaging direction, is restricted.

Further, as described above, the second support pieces 421-1a and 421-3a having a predetermined area are formed inside both of the lateral engaging pieces 421-1 and 421-3 of the first engaging piece 421 shown in FIG. 17. Upon engagement of the first engaging piece 421 and the second engaging piece 422, the two second engaging pieces 422 are disposed on the second support pieces 421-1a and 421-3a, and thus the two second engaging pieces 422 are supported by the second support pieces 421-1a and 421-3a not to be pushed even when an external force is applied.

When the objects (for example, papers) are bound using the binder ring for bookbinding 400 according to the present invention, the rib may be formed at the main body 410 to prevent dislocation of the papers and maintain elasticity and a reinforcement force of the main body 410.

That is, while not shown in FIG. 14, the rib 160 (having various shapes formed at the main body 110) shown in FIG. 8 may be formed at the inner surface of the main body 410. The rib having the projection structure can be formed at an edge of the inner surface of the main body 410 and can extend in the circumferential direction. However, of course, the formation position and the number of the ribs are not restricted.

The present invention configured as above may enable easy engagement and disengagement and may be appropriately applied to various thicknesses of the bookbinding through diversification of color or size. In addition, the number of ribs can be freely determined according to the size of the binding objects through individual use, and movement of the binding objects can be restricted through configuration of the ribs.

While the main bodies 110 and 410 of the binder rings 100 and 400 according to the embodiments shown in the drawings have the uniform thickness in the entire region, the present invention is not limited thereto. That is, in the regions of the main bodies 110 and 410, the thickness of the region opposite to the region at which the engaging portions 120 and 420 are formed may be smaller than the thickness of the region at which the engaging portions 120 and 420 are formed.

As described above, the main bodies 110 and 410 are formed of an elastic material. Accordingly, since flexibility of the region having a small thickness is larger than that of the other region, good elasticity can be provided upon engagement and disengagement of both of the engaging pieces 121 and 122, and 421 and 422.

In addition, as shown in FIG. 14, an open section 410a may be formed at the main body 410 of the binder ring 400 in a longitudinal direction thereof, and stoppers 411 and 412 may be formed at both ends of the open section 410a and boundary sections of the first and second engaging pieces 421 and 422.

An extension piece 210b having a predetermined length and dividing the punched hole 210a is formed at a portion of the binding objects, at which the binder ring 400 is used, i.e., a center of a punched hole 210a formed in the bookbinding matter (i.e., the bound objects) having the shape shown in FIG. 11, and the extension piece 210b can move along the open section 410a formed at the main body 410 in the longitudinal direction. However, when the extension piece 210b of the cover 210 corresponds to and comes in contact with a stopper 411 or 412 disposed at a tip of the open section 410a of the main body 410, additional movement of the cover 210 is not allowed.

In particular, when the user continuously rotates the cover 210 of the bookbinding matter in a state in which the extension piece 210b of the cover 210 corresponds to and contacts the stopper 411 disposed at the tip of the open section 410a of the main body 410, the extension piece 210b of the cover 210 rotates the binder ring 400, and thus the engaging portion 420 of the binder ring 400 corresponds to the binding papers. Eventually, the engaging portion 420 of the binder ring 400 cannot be seen from the outside, improving an outer appearance thereof.

The foregoing description concerns an exemplary embodiment of the invention, is intended to be illustrative, and should not be construed as limiting the invention. The present teachings can be readily applied to other types of devices and apparatuses.

Many alternatives, modifications, and variations within the scope and spirit of the present invention will be apparent to those skilled in the art.

1. A binder ring for bookbinding configured to bind binding objects having a punched hole to bind a bookbinding matter, comprising: a main body having elasticity and engaging portions formed at both longitudinal ends of the main body and configured to disengageably engage with each other,
wherein the engaging portions comprise a vertical disengagement restriction unit configured to prevent disengagement in a vertical (upward and downward) direction and a horizontal disengagement restriction unit configured to prevent disengagement in a horizontal (left and right) direction.

2. The binder ring according to claim 1, wherein the engaging portions are constituted by a plurality of first and second engaging pieces extending from both longitudinal ends toward each other and in which the horizontal disengagement restriction unit and the vertical disengagement restriction unit are formed, and the corresponding first engaging pieces and the second engaging pieces are alternately disposed to engage with each other.

3. The binder ring according to claim 2, wherein the horizontal disengagement restriction unit comprises a fixing protrusion formed at the first engaging piece and a fixing groove formed at a side surface of the second engaging piece to correspond to the fixing protrusion.

4. The binder ring according to claim 3, wherein the fixing groove is divided into a horizontal section formed at a front end thereof and a curved section formed at a longitudinal end so that the fixing protrusion enters the curved section along the horizontal section formed at the front end of the fixing groove and is disposed at a longitudinal end of the curved section by elasticity of the first engaging piece, and a push section is formed at a surface of the first engaging piece at which the fixing protrusion is formed.

5. The binder ring according to claim 2, wherein the horizontal disengagement restriction unit is constituted by a fixing protrusion formed at a front end lower portion of the first engaging piece and a concave section formed at a lower surface of the second engaging piece and corresponding to the fixing protrusion, the fixing protrusion and the front end of the concave section are formed as inclined surfaces so that the fixing protrusion is accommodated in the concave section by elasticity of the first engaging piece when the fixing protrusion corresponds to the concave section upon engagement of the first engaging piece and the second engaging piece, and a push section is formed at a surface of the first engaging piece at which the fixing protrusion is formed.

6. The binder ring according to claim 2, wherein the vertical disengagement restriction unit is constituted by a projection guide formed at a side surface of the second engaging piece and a guide groove formed at the corresponding side surface of the first engaging piece and into which the projection guide is inserted upon engagement of the first engaging piece and the second engaging piece.

7. The binder ring according to claim 2, wherein the vertical disengagement restriction unit and the horizontal disengagement restriction unit are constituted by a projection formed at a longitudinal end of the main body and an engaging groove formed at another longitudinal end and corresponding to the projection, a fixing key is formed at one side of the projection, and a fixing groove to which the fixing key is hooked and fixed is formed at the engaging groove.

8. The binder ring according to claim 1, wherein the main body comprises a reinforcement rib having a predetermined height formed at the inner surface.

9. The binder ring according to claim 8, wherein the rib is formed at an edge or a center of the main body and extends in a circumferential direction thereof.

10. The binder ring according to claim 8, wherein the rib is formed at an edge and a center of the main body and extends in a circumferential direction thereof.

11. The binder ring for bookbinding according to claim 1, wherein the main body has at least one reinforcement rib formed at a predetermined region of an inner circumferential surface thereof, and a stopper formed at the other region and having a thickness corresponding to a height of the rib.

12. The binder ring according to claim 1, wherein the main body has at least one cross-sectional shape selected from a circular shape, a semi-circular shape having a partial plane, an oval shape, a rectangular shape, and a shape having different radii of curvature according to regions.

13. The binder ring according to claim 1, wherein the main body and the engaging portions are formed of different materials.

14. The binder ring according to claim 1, wherein the main body and the engaging portions are formed of any one of a synthetic resin, a metal, a non-metal, and a metal alloy, and a region of the main body has a thickness which is smaller at a region opposite to the region at which the engaging portions are formed than the region at which the engaging portions are formed.

15. The according to claim 2, wherein the first and second engaging pieces have any one shape of a concavo-convex shape, a sawtooth shape, and a shape having a predetermined radius of curvature, which are alternately engaged with each other.

16. The binder ring according to claim 2, wherein the horizontal disengagement restriction unit is constituted by an extension piece extending outward from a central engaging piece of the first engaging piece, and a concave section formed at a lower portion of the second engaging piece corresponding to the central engaging piece to a predetermined depth, the extension piece of the pushed first engaging piece returns and is accommodated in the concave section of the second engaging piece upon engagement of the first engaging piece and the second engaging piece, and in this state, vertical disengagement of the second engaging piece and the first engaging piece is suppressed by the vertical disengagement restriction unit.

17. The binder ring according to claim 16, wherein the front end of the concave section formed at the second engaging piece is an inclined section having a lower surface formed of an inclined surface, and the inclined section is formed at a region corresponding to the extension piece formed at the central engaging piece of the first engaging piece.

18. The binder ring according to claim 16, wherein the vertical disengagement restriction unit is a first support piece extending from the main body corresponding to both of the lateral engaging pieces of the first engaging piece toward the first engaging piece and formed at the outside of the second engaging piece, and the front end of the lateral engaging piece of the first engaging piece is supported in a state disposed on the first support piece upon engagement of the first engaging piece and the second engaging piece.

19. The binder ring according to claim 18, wherein the front end of the lateral engaging piece has a thickness increased toward the main body adjacent thereto so that the lower surface is formed of the inclined surface, and a surface of the first support piece is formed of an inclined surface inclined upward toward the main body adjacent thereto.

20. The binder ring according to claim 18, wherein the vertical disengagement restriction unit further comprises a second support piece formed inside the lateral engaging piece of the first engaging piece, and upon engagement of the first engaging piece and the second engaging piece, the second engaging piece is disposed and supported on the second support piece.

21. The binder ring according to claim 16, wherein the main body has an open section formed in a longitudinal direction thereof, and stoppers are formed at both longitudinal ends of the open section and a boundary section of the first and second engaging pieces.
